(19) United States
(12) Patent Application Publication
(10) Pub. No.: US 2019/0124447 A1
(43) Pub. Date: Apr. 25, 2019

(54) METHOD FOR REPRODUCING SOUND, TAKING ACCOUNT OF INDIVIDUAL REQUIREMENTS

(71) Applicant: Pierre Vincent, Ecquevilly (FR)

(72) Inventor: Pierre Vincent, Ecquevilly (FR)

(21) Appl. No.: 16/090,390

(22) PCT Filed: Mar. 31, 2017
(86) PCT No.: PCT/FR2017/050743

§ 371 Date: Oct. 1, 2018

(30) Foreign Application Priority Data
Apr. 5, 2016 (FR) 1652985

(51) Int. Cl. H04R 3/12; H04R 5/04; H04R 1/34; H04R 5/02; A47C 7/72

(52) U.S. Cl. CPC H04R 3/12; H04R 5/04; A47C 7/727; H04R 5/023; H04R 1/345

(57) ABSTRACT

An audio system for reproducing sound in a collective space contains a plurality of individual armchairs, each armchair being equipped with a sound reproduction means connected to a common source. Each of the sound reproduction means comprises a specific correction circuit equipped with a means for communicating with a personal device so as to read a configuration file saved in a personal device of the user of the corresponding armchair.

### CROSS-REFERENCE TO RELATED APPLICATIONS

This application is a national phase entry under 35 U.S.C. § 371 of International Patent Application PCT/FR2017/050743, filed Mar. 31, 2017, designating the United States of America and published as International Patent Publication WO 2017/191384 A1 on Nov. 9, 2017, which claims the benefit under Article 8 of the Patent Cooperation Treaty to French Patent Application Ser. No. 1652985, filed Apr. 5, 2016.

### TECHNICAL FIELD

The present disclosure relates to the field of theater equipment and, specifically, cinemas or theaters, or home cinema in a dedicated location or in a living room or a living space (“home cinema”) and especially kinesthetic 3D and 4D sound reproduction equipment.

### BACKGROUND

In such collective or private spaces, the electro-acoustic part is very important for controlling the reproduction of sound. It is called chain B in the ISO 2969:2015 International Standard.

The distribution of the points of reproduction in the room generally corresponds to the so-called 5.1 digital systems having three main screen channels and two surround sound channels in the room and one channel dedicated to the very low frequencies, positioned behind the screen. This choice was made to provide the best possible distribution of sound in the room, and also to allow using more or less spectacular sound effects. The bass enhancement channel (20 to 80/100 Hz), which reproduces the deepest sounds only, plays a major part in the dramatic effect. Besides, such vibrations, which spread easily, are felt by the whole body and not only by the ears.

Another solution of the 6.1 type, known under the trade names Surround EX or DTS-ES, is a variant of this provision. The surround sound channels are then distributed into three channels: left, right and rear. The screen channels do not change.

The listening level is identical in mixing auditoriums and in theaters. It usually corresponds to a reference level of 78 to 85 decibels, depending on the configuration and size of the room or listening location. It should not vary from one film to another since the sound levels of each scene are determined upon mixing, on the basis of the desired effects and sensations, in reference to that listening level. A variation in this level would not only affect the artistic intentions by changing the overall dynamics of the film, but would also affect the listening quality by becoming sometimes too low or dangerously too high.

These solutions take no account of individual listening specificities. In view of the discomfort caused by some over-mixed films (with the reference of 85 decibels being exceeded), operators had to arbitrarily lower the listening level. The reference level is then no longer complied with. This is detrimental to the other movies and distorts the sound post-production work.

All the B chain settings—frequency and listening level response—are made through the cinema processor provided in the room, or through the audio-video amplifier, without taking into account the audience's individual preferences.

An alternative solution is to equip the room with armchairs incorporating loudspeakers to tailor the reproduction of sound.

### PRIOR ART

To remedy this collective reproduction issue, it was also proposed to equip the armchairs with individual sound reproducing systems. The international patent application WO 2010/028483, for instance, describes such an ambiophonic headrest provided with several loudspeakers for generally reproducing an ambiophonic sound experience. The headrest generally includes a central portion provided with at least one loudspeaker, a first side portion provided with at least one loudspeaker, and a second side portion provided with at least one loudspeaker. The side portions are arranged on each side of the central portion and extend substantially perpendicularly toward the top relative to the central portion. The headrest is arranged to be connected to an audio signal source capable of generating several different audio signals.

The patent application US 2010/0320819 is also known in the state of the art.

This disclosure relates to a recliner seat including transducers for transmitting vibrations to a user's body in order to provide vibratory or auditory stimuli for a treatment of the nervous system. It is specified that these neuro-stimulation and relaxation sessions can be performed while the user is listening to music or playing a video game, with the sound being, of course, transmitted by means other than the vibration generators integrated in the armchair.

The subject of this disclosure of the prior art does not relate to the scope of the present disclosure but to a very different field, which is that of neuro-relaxation by vibration application.

### Drawbacks of the Prior Art

Prior art solutions are not satisfactory. Collective sound reproduction does not take into account individual auditory preferences.

In the solutions involving armchairs equipped with individual sound broadcasters, the problem remains the same since the sound source is common to all the armchairs and does not make it possible to take into account the auditory preferences of the members of the audience.

This is the reason why theaters are subject to recurrent criticism from the audience, dissatisfied with the quality of the sound system: too high volume, excessive sound level, insufficient perceived quality of sound, imbalance between the level of dialogue and the level of the background noise or music. Most of the innovations concern new sound experiments on sound spatialization, etc., but do not remedy the basic reasons for dissatisfaction.

### BRIEF SUMMARY

In order to remedy these drawbacks, the present disclosure, in its broadest sense, relates to a system for reproducing sound in a collective space containing a plurality of individual armchairs, each equipped with a sound reproduction means connected to a common source, wherein each of the sound reproduction means comprises a specific correction circuit equipped with a processor and a means for communicating with a personal device, so as to read a configuration file saved in the personal device of the user of the corresponding armchair.

This configuration file may consist of a digital audiogram, for instance, as an impulse response signal.

In an alternative solution, the digital audiogram is saved in a remote resource (the cloud, a server, etc.), with the armchair being associated with means for downloading the corresponding file based on customization information of the member of the audience sitting in the armchair.

The configuration files are advantageously saved on a remote support, with the armchair having means for communicating with the support according to the user's customization information.

According to another alternative solution, the communication means is of the near field communication (NFC) type.

According to another alternative solution, each of the armchairs comprises a display screen for viewing a code for matching with the corresponding user's personal device.

According to a third alternative solution, each of the armchairs comprises a connector for communicating with the corresponding user's personal device.

According to a specific embodiment, the system further comprises a server for saving the configuration files and calculating information for allocating individual armchairs based on the various configuration files saved.

Advantageously, it further comprises a server for saving the configuration files and controlling a plurality of armchairs provided in one zone of the collective space by a common configuration file calculated according to the users' various individual configuration files in the zone.

According to a specific embodiment, the common configuration file is calculated based on the users' various individual configuration files in the zone and based on a second type of individual parameter.

According to an alternative solution, the configuration file comprises spectral filtering parameters.

According to a specific embodiment, the configuration file consists of an impulse response and each of the armchairs includes an impulse response filter.

The armchairs are preferably equipped with directional loudspeakers having a variable directivity to enable adaptation to the member of the audience sitting in the armchair.

According to a specific embodiment, the directional loudspeakers consist of acoustic line arrays, with directivity thereof being controlled by a system controlled by sensors detecting the person's position and conformation.

### BRIEF DESCRIPTION OF THE DRAWING

The present disclosure will be better understood upon reading the following description, with reference to the accompanying drawing in which:

FIG. 1 is a perspective view of a theater room equipped with a series of armchairs as described herein.

### DETAILED DESCRIPTION

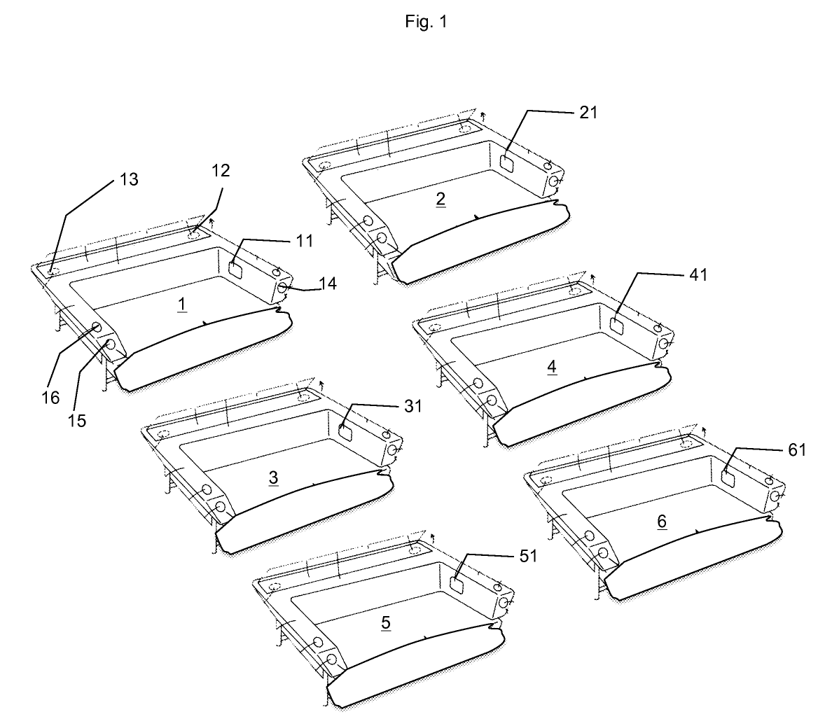

FIG. 1 shows an exemplary embodiment of a system according to the disclosure. The theater room is equipped with a series of armchairs 1 to 6.

Each armchair is equipped with directional loudspeakers 12 to 15 that reproduce sound and emit the sound toward the user sitting in the armchair.

Each armchair is additionally equipped with a presence detector controlling the interruption of the sound reproduction by the loudspeakers fitted therein if the user is no longer sitting in the armchair.

The armchairs 1 to 6 are also provided with an electronic circuit 11 to 61, which comprises a radiofrequency receiver, for example, BLUETOOTH®, which makes it possible to communicate with a user's device, for example, a cellular phone. The armchair comprises, in the described example, a display screen 16 for viewing a code for matching with the cellular phone of the user sitting in the corresponding armchair.

When the connection is established, an application downloads a user's personal configuration file, controlling an electronic filter driving the reproduction of sound through the loudspeakers 12 to 15 of the respective armchair.

Such a configuration file, for example, consists of an XML, file, wherein the user-tailored spectral filtering parameters are saved, which have been downloaded upon the user sitting in an armchair.

This file can also consist of an audiogram prepared, for example, by a hearing prosthetist and saved or uploaded to the user.

This file is used by the circuit 21 to control a multi-band equalizer and to set a personal response adapting the sound reproduction by the loudspeakers of the armchair in which the user is sitting.

The configuration file can also be a file of the WAV type, which corresponds to the saving of an impulse response, which is then used by a convolution circuit that multiplies the signal downloaded by the armchair user with the collective sound signal reproduced in all the armchairs 1 to 6 by the theater room operator.

The armchair 1 to 6 may also comprise a connector for connecting a tablet or a cell phone thereto, thus enabling, on the one hand, the transfer of the configuration file and, on the other hand, electric charging of the tablet or cell phone.

The configuration file can, according to an alternative solution, be transmitted beforehand to a server distributing the files to the respective users' armchairs so as to enable grouping users whose files are similar in the same zone. Such files can also be saved by the user into the cloud.

In this case, sound reproduction can be identical for all the armchairs of the respective zone, for example, with an equalization calculated by aggregating the individual configurations of the users situated in the same zone. Such aggregation can be weighted by an additional parameter, for instance, a digital value representative of the user's loyalty, as a function of the frequency of attendance in the theater room or of the category of the price paid.

According to another alternative solution, the loudspeakers intended for the user of an armchair 1 are, for some of them, integrated in the adjacent armchair 3 so as to enhance the sound spatialization. In this case, the loudspeakers in the adjacent armchair 3 are controlled by the electronic circuit 11 of the user's armchair 1, and the configuration file is transmitted by the latter to the circuit 31 of the armchair 3.

The armchair can also provide for means for acquiring information on the user's morphology, such as size, so as to control the spatialization of sound reproduction to the armchair in which the user is sitting.

According to an alternative solution, the armchairs 1 to 6 are bucket seats provided with sound bars or, preferably, directional acoustic line arrays, with controlled directivity in the rear and side parts, so as to define a small-apertured sound reproduction lobe.

The acoustic line arrays consist of a network of (“in line”) one-dimensional acoustic enclosures, enabling the reproduction of sound, with directivity being controlled by the phase and amplitude of the signal applied to each of the broadcasters. For purposes of the present disclosure, the acoustic line array has a size between 15 and 40 centimeters, preferably of the order of 20 cm, and is equipped with micro-transducers, the section of which is between 0.5 cm and 2 cm.

The armchair 6 in front of the user's armchair 4 comprises acoustic line arrays oriented toward the user's armchair 4. The back of the armchair 6 can also comprise a camera for recognizing the position of the user's head in the armchair 4 in the next row, in order to optimally control the orientation and the directivity of the sound broadcasters, depending on the size and the position of the head of the user of the armchair 4 located behind the armchair 6 equipped with this camera.

The camera can also be a camera placed near the screen, for example, a living room screen.

The armrests of the armchair can each have one acoustic line dynamically directed toward the ear of the member of the audience. The orientation of each of the acoustic line arrays can be controlled by a camera analyzing the position of the armchair user.

Each user receives the sound signal from 6 to 14 acoustic line arrays:
two to three side acoustic line arrays, positioned on the right and on the left, and optionally at the center, in the headrest of the user's armchair;
two to four acoustic line arrays, positioned in the armrest of the armchair, on the right and on the left, inside the user's armchair; and
two to four front acoustic line arrays, positioned on the right and on the left, and optionally at the center, in the rear part of the armchair located in front of the user's armchair.

Optionally, the seat of the armchair may have four additional acoustic line arrays arranged in the front-rear direction, on either side of a center line so as to produce the “ground” effects, such as the sound of a river for bridge crossing scenes.

This alternative solution makes it possible to offer the audience a rich three-dimensional sound experience close to them, while adapting the sound experience to their sensory characteristics, in a public or private theater room with a large audience with different sensory profiles.

Each armchair may further be equipped with a subwoofer, also driven by the configuration file, so as to enable an individual adjustment of this parameter for which there is a high variability of perception as a function of the user and which provides a kinesthetic effect. This parameter can thus be adapted to each user's perception, from the signal distributed by a central device, and the personal configuration file of the user in the armchair.

The armchair may also include a footrest in which a vibrator is incorporated to reproduce kinesthetic effects that can be felt by the respective user.

The setting of the armchairs in a listening zone can take into account each user's personal information, with a weighting of the configuration file according to parameters such as each user's passage frequency, or the price paid.

A calculator performs neighbors' profile aggregation calculations for one zone of the space with a restriction in dynamics variation.

### Alternative Embodiment

According to one alternative embodiment, the sound reproducing system further comprises one or more camera(s) for acquiring the head morphology of the persons in the audience and the automatic calculation, for each identified person, of data that characterizes the modifications brought in the sound wave by one listener's body.

Such HRTF (head-related transfer function) data is then transmitted to the device of the corresponding armchair so as to recreate a three-dimensional sound environment with loudspeakers from a binaural signal common to all armchairs and applying a binaural method according to the HRTF data.

Analyzing images makes it possible to extract the faces and to determine the personal head morphology of the persons sitting in the various armchairs thanks to the characterization parameter such as the distance between the ears, the orientation of the interaural axis, the interaural level difference (ILD) determined as a function of the face morphology which acts as a masking and diffracting barrier.

These parameters are then used to calculate, for each armchair, a HRTF (Head Related Transfer Function) for customizing the audio signal delivered by the sound reproducing means 12 to 15 of each armchair, according to the transaural technique, which makes it possible to reproduce a spatialized sound environment with enclosures using a binaural signal.

The method implements various filtering operations intended to cancel the crossed paths while maintaining the timbre of the recording.

The acquisitions relating to the HRTF are processed using automated machine learning techniques, which make it possible to deduce standard profiles generating simple algorithms requiring low computing power.

1. A system for reproducing sound in a collective space, comprising: a plurality of individual armchairs, each armchair being equipped with a sound reproduction device connected to a common source, wherein each of the sound reproduction devices comprises a specific correction circuit equipped with a device for communicating with a personal device so as to read a configuration file saved in a personal device of a user of the corresponding armchair.

2. The system for reproducing sound of claim 1, wherein the communication device comprises a near field communication (NFC) device.

3. The system for reproducing sound of claim 1, wherein the configuration files comprise a digital audiogram saved in a remote resource, with the armchair being associated with a device for downloading the corresponding file based on customization information of a user sitting in the armchair.

4. The system for reproducing sound of claim 1, wherein each of the armchairs comprises a display screen for viewing a code for matching with the corresponding user's personal device.

5. The system for reproducing sound of claim 1, wherein each of the armchairs comprises a connector for communicating with a user's personal device.

6. The system for reproducing sound of claim 1, wherein the system further comprises a server for saving the configuration files and calculating information for allocating individual armchairs based on the various configuration files saved.

7. The system for reproducing sound of claim 1, wherein the system further comprises a server for saving the configuration files and controlling a plurality of armchairs provided in one zone of the collective space by a common configuration file calculated according to the users' various individual configuration files in the zone.

8. The system for reproducing sound of claim 7, wherein the common configuration file is calculated based on the users' various individual configuration files in the zone and based on a second type of individual parameter.

9. The system for reproducing sound of claim 1, wherein the configuration file comprises spectral filtering parameters.

10. The system for reproducing sound of claim 1, wherein the configuration file comprises an impulse response and wherein each of the armchairs includes an impulse response filter.

11. The system for reproducing sound of claim 1, wherein the armchairs are equipped with directional loudspeakers.

12. The system for reproducing sound according to claim 11, wherein the directional loudspeakers comprise acoustic lines.
